(19) United States
(12) Patent Application Publication
(10) Pub. No.: US 2022/0155765 A1
(43) Pub. Date: May 19, 2022

(54) VERIFYING A COMPATIBILITY OF A PROCESS MODULE OF AN AUTOMATION SYSTEM TO BE NEWLY INTEGRATED

(71) Applicant: Festo SE & Co. KG, Esslingen (DE)

(72) Inventors: Christian Barth, Wendlingen (DE); Christian Markwart Stich, Hirschberg (DE); Matthias von Zeppelin, Lichtenwald (DE)

(21) Appl. No.: 17/525,741

(22) Filed: Nov. 12, 2021

(30) Foreign Application Priority Data
Nov. 13, 2020 (DE) 10 2020 130 022.0

(51) Int. Cl. G05B 19/418

(52) U.S. Cl. CPC G05B 19/41865; G05B 19/4188; G05B 19/41885; G05B 19/4184

(57) ABSTRACT

A computer-implemented method for checking a compatibility of a new process module to be integrated with at least one other process module in a modular network of process modules for controlling an automation unit is provided. The computer-implemented method includes acquiring a first process module description of the new process module to be integrated, retrieving a second process module description of the at least one further process module; and verifying compatibility by performing a functionality comparison function on the acquired first and retrieved second process module descriptions.

### CROSS REFERENCE TO RELATED APPLICATIONS

This application claims priority to German patent application 10 2020 130 022.0, filed Nov. 13, 2020, the entire content of which is incorporated herein by reference.

### TECHNICAL FIELD

The present disclosure relates to checking a compatibility between a process module to be newly integrated and at least one further process module. The process modules may be designed to be interconnected in a modular network of process modules and/or are already interconnected in a modular network of process modules and serve to control and/or operate an automation system or an automation unit.

### BACKGROUND

Automation units are used, for example, in industrial automation, process automation and/or manufacturing automation, such as in the pharmaceutical industry, the food industry or the beverage industry (filling plants, etc.). For example, in the automation unit the flow of a fluid, in particular a process fluid, can be controlled with a valve device. For this purpose, a modular automation unit may be constructed from a plurality of process modules. A plant section of the automation unit may thus be provided with one or more defined functions for a particular process step. Due to the increasing degree of specialization and the special tasks that the automation units have to perform, both the scope of the individual process modules and the overall scope of the automation unit are constantly increasing. Modularization allows new functions to be implemented more quickly or faulty process modules to be replaced more quickly. However, this can have the consequence that an integration of the individual process modules into an automation unit becomes more complex and extensive, especially if the individual process modules are provided by different producers or if the respective process modules differ in their functions. In addition, the process modules may have different hardware interfaces and communication protocols for providing their functions, which may make uniform integration difficult. Different functions as well as properties of the process modules make it difficult to implement the process modules in the modular network of process modules without errors. Due to the modular structure of an automation unit, a specific plant part (process module) with a defined function can be provided by a producer for a specific process step of the automation unit.

Problems can arise from the fact that each process module has, among other things, manufacturer-specific logic, programming and operation. In addition to transmission protocols, the alarms and messages generated by the process modules as well as the visualization of all control parameters must also be properly integrated into the process control level, such as in the control system or IVIES (IVIES: Manufacturing Execution System). MES refers to a level of a multi-layer manufacturing management system that operates close to the process. A MES system increases the level of process automation and enables real-time management, guidance, control and/or monitoring of production. Below the plant management level/MES lies the process management level (SCADA) and below that again the field level. The information technology integration of individual process modules is therefore not trivial.

For the integration of new process modules into an existing or to be formed network of process modules in an automation unit, for example a plant, factory or hybrid plant, and also for the communication of the process modules with each other and for the communication of the process modules with the automation unit, for example, the communication standard OPC-UA (Open Platform Communications Unified Architecture), which has meanwhile been set, is used. This manufacturer-independent standardized communication protocol is used to exchange data across machines. The OPC-UA architecture is a service-oriented architecture (SOA) whose structure comprises several layers.

Communication technology is supplemented by another standard, the Module Type Package (MTP), for the digital description of the control integration of process modules into the automation unit in the context of modular production for the process industry. With the MTP standard, properties of process modules can be described functionally, in particular in a manufacturer- and technology-neutral manner. The MTP standard makes it possible that all necessary information for the operation of the automation unit, such as module properties, state descriptions, interfaces as well as a phenomenological description of the operator interfaces, in particular the operator screen elements, can be transmitted in a standardized manner.

The MTP is based on the Automation Markup Language (AML). AML can be understood as a language in which a file is created. AML is thus a format for data exchange, which is in particular XML-based. The electronic file in formalized and/or machine-readable form thus represents or is a functional description of the process module and is generated from the engineering data of the process module automation. It enables any higher-level automation system that “speaks” MTP to correctly control a specific module—for example, a centrifuge, a granulator or a homogenizer.

A potential weakness of the automation units known in the prior art so far, which are based on an implementation with an MTP description file of a process module, is that it cannot be traced whether the MTP description file has also been created according to the standard and thus meets its requirements. Known prior art methods provide that a new process module is integrated into an automation unit via its MTP description file. If the MTP description file (process module description) deviates from the MTP standard, this can result in an error of the entire automation unit after commissioning of the newly integrated process module. In addition, an MTP description file that deviates from the MTP standard can make commissioning of the new process module to be integrated more difficult. In both cases, downtimes can occur for the use of the process module to be integrated itself as well as for the entire automation unit, since errors in an MTP description file to be integrated can affect the entire automation unit.

### SUMMARY

Based on foregoing, the present disclosure is based on a technical object of checking an MTP description file of a process module to be integrated in an automation unit before its integration for conformity with the formal descriptions of process modules/automation units, in particular for conformity with the MTP standard and for compatibility with existing process modules.

This object is achieved by a computer-implemented method, a use of the same, a process-industrial computing unit and a computer program as described herein.

According to a first aspect, the disclosure thus relates to a computer-implemented method for checking a compatibility of a new process module to be integrated with at least one further process module. The new process module to be integrated and/or the further process module may be intended to be integrated in a modular network of process modules for controlling an automation unit. Typically, the computer-implemented process comprises the following process steps:
Acquiring a first process module description of the new process module to be integrated; Retrieving a second process module description of the at least one further process module; and
Verifying compatibility by performing a functionality comparison function on the acquired first and retrieved second process module description.

Typically, the checking may comprise checking the compatibility of the new process module to be integrated with at least one other process module in the modular network into which the new process module is to be integrated, for example. According to one embodiment of the disclosure, it may also be provided that the compatibility of the new process module is checked with a previously determined selection of process modules or with each process module of the modular network.

A process module is a module with a specific function for execution in the automation unit (e.g., production plant). The function is represented in the process module description. For example, process modules may include dispensing modules and/or reactor modules (e.g., bioreactor modules) that may be implemented in the modular compound. Further, an existing automation system having a plurality of components and modules may have their functionality considered and taken into account as a single module for integration of a new process module and for compatibility testing. Thus, a process module is to be understood as a standardized module which, by integration into a group of existing process modules, supplements or extends the group or network by desired functions. This can be done by replacing existing process modules, for example by replacing an old version with a new version, or by adding a new, additional function. Thus, automation systems or units can be built up and expanded according to the intended use and the needs and requirements of the operator. Integrating in the sense of the present disclosure comprises a hardware-technical and/or software-technical integration of the module to be integrated into a network of existing process modules, so that a technical unit which functions together is formed. For example, a library with corresponding functions can be provided for a controller (e.g., for a CPX controller as a modular peripheral system for valve terminals) as a process module, which provides MTP support that is used in a modular automation unit.

The “further process module” can be a process module which is an existing process module already implemented in a modular network of process modules. However, the further process module can also be a process module which itself is not yet a component of the group, but which is intended for implementation in the group and is to be checked for compatibility beforehand in accordance with the disclosure. Thus, the compatibility of process modules with each other or among each other can be checked.

For the purposes of the present disclosure, compatibility means the interchangeability of process modules and/or the compatibility of properties of the process modules and/or the equivalence of the properties of the process modules, in particular for a specific task (functionality). If a process module to be integrated meets required requirements of at least one of all existing process modules of the modular network of process modules for controlling an automation unit, it is referred to as being compatible with the latter. Checking compatibility may comprise checking conformity with a general description of process modules/automation unit, for example a predefined standard, in particular with the MTP standard. In particular, this concerns the verification of syntactic properties of the file to be checked and/or the actual specifications that have to be fulfilled according to the standard in order to be considered MTP compliant. Thus, the function or functionality of a process module may be represented in the form of a process module description, the process module description typically being MTP standard compliant.

Furthermore, a separate control logic is provided for the process module. The process module functions in the form of corresponding services (functions) can be provided via a type of communication interface, e.g., via a server in accordance with the OPC UA standard. In this respect, all relevant status information on the part of the process module can be transmitted to the automation system. It is also possible to parameterize and to start services.

For the purposes of the present disclosure, an acquisition of a first process module description is to be understood as reading and/or evaluating (parsing) the process module description of the process module to be integrated. The process module description may be provided by the process module to be integrated itself, for example by reading a memory. Alternatively, the process module description may be provided and acquired via an external memory, separate from the process module. The acquiring may comprise copying the process module description to a further memory for execution of a functionality comparison function by a processing unit with access to this memory and/or reading via an interface. For the reading and/or evaluation (parsing), methods and/or techniques for data processing known in the prior art may be used.

Furthermore, for the purposes of the present disclosure, retrieving a second process module description is to be understood as reading out existing process module descriptions, for example from a memory. In this context, retrieving a second process module description comprises reading out at least the process module description stored in an electronic file. The retrieval serves to check a compatibility of the new process module to be integrated with further and/or existing process modules. The process module description of the further/existing process module(s) may be provided via a central memory. Alternatively, the process module description can be provided decentrally by the process module(s) themselves.

Furthermore, the Module Type Package (MTP) standard is a standard for the digital description of the control integration of process modules into the process control level in the context of modular production for the process industry. The standard is based on the VDI/VDE/Namur guideline 2658. The MTP standard standardizes the digital description of the process module, including the visualization in the form of an operating screen, and enables interoperability of process modules.

For the purposes of the present disclosure, a functionality comparison function is to be understood as a function which provides the electronic or digitized and automated comparison of a process module description, in particular a description file of a process module to be newly integrated, with the description file of a further process module. The description file stores the process module description in a processable or editable manner. The functionality comparison function may be implemented in software and/or hardware and is executed by a processor. In particular, the functionality comparison function may be executed in an automated manner. By a comparison is meant a method by which equality and inequality of process module descriptions to be compared can be detected. According to specific requirements on the process modules and/or on the automation system, the equality may comprise a 100% equality or alternatively a threshold value of an equality to be achieved. The functionality comparison function may comprise a parsing of two or more electronic files. In this regard, the functionality comparison function reads, for example, the data types, service names, parameters, technical specifications (value matching) and/or data flow directions used and compares them for equality. Furthermore, it can be provided that an analysis of a checksum of the description file is additionally performed via the functionality comparison function in order to detect an equality or inequality.

The present disclosure is based on the knowledge that there is a need for checking a compatibility of a new process module to be integrated with at least one other process module in a modular network of process modules for controlling an automation unit.

Currently known methods for integrating process modules to existing process modules using the process module description encoded with the MTP standard do not provide for a compatibility check of the process module description before integration into the modular compound of process modules.

Advantageously, the present disclosure covers the process module description not only for the general check of compatibility with another process module description, but also for compatibility or conformity with the actual MTP standard. In addition, the requirements imposed on the MTP standard are verified. Furthermore, the present disclosure may verify a reasonable implementation of the process module description in the context of the MTP standard. The verification of the meaningful implementation may comprise a semantic verification. Among other reasons, the verification of the meaningful implementation is important because a mere verification for syntactic compatibility with the used MTP standard cannot ensure a usable internal referencing for the use case. This is necessary because internal referencing is mandatory in the MTP standard. Internal referencing means an internal reference identification (reference ID) that specifies the relationship between elements in relation to each other. In this way, the elements that have a reference to each other can be linked to each other and processed or evaluated as belonging to each other. From the syntactic point of view, the reference ID can point to any other element. Ensuring that internal referencing is usable, ensures that referencing is useful and used correctly. For example, it can be ensured that a valve symbol in the visualization of a component points to and accesses the correct and associated data instance.

It is further advantageous that the compatibility between two process modules can be automatically checked by the present disclosure and in particular before they are released for implementation in the automation system. A decisive advantage of the automatic check is, in the case of an expected increase in the process module product portfolio, that a preselection of compatible process modules can already be automatically generated before the actual implementation in the automation system. This makes the selection process for process modules, which in the final instance should still be approved at least manually by an integrator, significantly more efficient, faster and simpler.

In one embodiment of the disclosure, the result of the compatibility check is made available to an integrator (electronic module, e.g. component of a control station), to a user of a computing unit, in particular to a person in charge of the automation unit and/or to further entities, on the basis of which a decision is made as to whether the new process module to be integrated can/should be integrated into the automation unit in order thus to form a modular network or compound with the existing process modules.

In an alternative embodiment of the disclosure, the process module to be integrated may be integrated in the automation unit in terms of hardware (electrical and/or mechanical) and/or software with the function not yet activated. After checking the compatibility, the functions of the integrated process module can be activated. Thus, the occurrence of a malfunction in the automation unit due to possible incompatibility or conformity is prevented.

In a preferred embodiment of the disclosure, the first and/or the second process module description comprise a description file in an Automation Markup Language format, in particular according to the MTP standard. The process module description represents control logic information for operation in the automation unit.

The Automation Markup Language (AutomationML) format is a neutral data format based on the Extensible Markup Language (XML) for storing and exchanging planning data for automation units. The process module description provided in the AutomationML format can make the exchange of control logic information and/or engineering data more efficient and simplified in a heterogeneous user tool landscape of engineering tools for different industrial process applications, e.g., for programmable logic controller (PLC) programming or for robot control. The AutomationML data exchange format is standardized in the IEC 62714-1:2018 standard. Using the AutomationML format, process modules can be described as objects with different aspects. An object can contain further objects and can itself be a part of a higher-level process module. Thus, the AutomationML format can be used to describe a hierarchical structure of a process module with different levels of detail.

In another preferred embodiment of the disclosure, checking compatibility comprises semantic checking. The semantic check can be used to determine whether functions provided by the new process module to be integrated match the requirements of the at least one further process module, and vice versa. Here, functions provided by the process module or by the new process module to be integrated are required to match the requirements of the new process module to be integrated or of the further process module. The functions of the process modules are stored and specified in the process module description according to the MTP standard. In particular, the necessary interfaces and their interface behavior are specified. If the semantic check determines that functions of a new process module to be integrated in particular do not meet the requirements of the (existing) other process module or vice versa, the result of the compatibility check is negative. Thus, even before a possible integration, it can be efficiently determined whether errors are to be expected or can occur, or errors are avoided. Likewise, the case may arise that existing process modules cannot meet the requirements for the functions of a new process module to be integrated. In this regard, if the functions of the new process module to be integrated are necessary, an update of the existing process modules can be provided.

In a further preferred embodiment of the disclosure, the new process module to be integrated and/or the at least one further process module provide alarm management as a function. Alarm management refers to a systematic management of alarms for each process module or for the automation unit as a superordinate system of process modules, in order to ensure usability for the corresponding operators of the automation unit. An alarm can be defined as an event that requires an immediate response from the automation unit operator. Isolated individual alarms can be configured for each process module. Essential for alarm management is the logging of all alarms in a corresponding database, which can be used for statistical evaluation and error minimization. In addition, the quality of the alarm system can be assessed on the basis of the characteristic values obtained (alarm rate, alarm times, alarm peak values, etc.) and appropriate measures can be implemented. The analysis of the occurring alarms can be a basis for efficient alarm reduction. Accordingly, it is necessary that the process modules cooperatively interconnected in the modular network have a correspondingly identical and/or compatible alarm management system. If it is determined through verification that the alarm management is not compatible with each other, integration may result in an error. This is avoided according to the disclosure.

In a further preferred embodiment of the disclosure, the process module to be newly integrated and/or the at least one further process module provide a safety method and/or security method as a function. In the sense of the present disclosure, all functions of the process module which relate to the safe operation and/or the safe operation of the process module and thus to the prevention of accidents are to be assigned to the safety method. All functions of the process module which relate to the protection of the process module and thus to crime prevention are to be assigned to the security method. Thus, the respective goals of the safety procedure and the security procedure can partly contradict each other. In the safety procedure, functions are implemented in potentially dangerous process modules and/or automation units in order to protect people and/or the environment from harm. With regard to the security method, the focus is not on protecting people (operators) from the process module and/or automation unit, but the other way round: an attempt is made to prevent the process module and/or automation unit from being damaged by people or to prevent relevant safety functions from being switched off. Accordingly, it is necessary that the process modules connected in the modular network have a correspondingly identical and/or compatible safety procedure and security procedure. If it is determined by the check that the safety procedure and security procedure of the further process modules and of the new process module to be integrated are not compatible with each other, an integration can lead to an error. Typically, appropriate error handling is performed, for example in the form of outputting an error report. The incompatibilities can be output or displayed via the error report.

In a further preferred embodiment of the disclosure, the new process module to be integrated and/or the at least one further process module provide as a function a process control and/or a process method. The specification of the monitoring of processes by a process control is specified by DIN EN ISO 9001. Within the scope of process control, process key figures are to be used to ensure that planned results are achieved in accordance with the specifications. With a targeted process control, a reproducible stability of the process procedures can be ensured. A monitoring of the automation unit and/or the further process modules of the compound (e.g. with suitable sensor technology) has the aim to recognize the effectiveness of the structure of the automation unit in its entirety and to further develop the automation unit based on the information gained. In order to implement a holistic process control, it is necessary that the process modules used in the automation unit are compatible with each other. This is advantageously achieved by checking the corresponding process modules. In addition, it can be achieved that only process modules are integrated which are compatible with the process method of the automation unit.

In a further preferred embodiment of the disclosure, the new process module to be integrated and/or the at least one further process module provide a maintenance and diagnostic procedure as a function. By using maintenance and diagnostic procedures, the economic efficiency, operational safety and environmental compatibility of used process modules and/or of the automation unit as a whole can be optimized. The maintenance and diagnostic procedures comprise an inspection as diagnosis, which is often accompanied by the immediately following maintenance or repair. In order to implement a holistic maintenance and diagnostic function, it is necessary that the process modules used in the automation unit are compatible with each other. This is advantageously achieved by checking the corresponding process modules. In addition, it can be achieved that only process modules are integrated which are compatible with the process method of the automation unit.

In a further preferred embodiment of the disclosure, the new process module to be integrated and/or the at least one further process module provide as a function a communication method. The communication method comprises communication of the process modules with each other and/or with the automation unit. In particular, the communication method comprises human-machine communication via the human-machine interface (HMI). Each process module may have one or more interfaces for the corresponding communication. Communication can only be ensured if the corresponding interfaces are compatible with each other. Accordingly, it is necessary that the process modules interconnected in the modular network use a correspondingly identical and/or compatible communication method and/or have compatible communication interfaces. If it is determined through verification that the communication methods are incompatible, integration may result in an error. In addition, incompatibilities, in particular for aspects of operation in the HMI may be pointed out and identified. According to the disclosure, therefore, advantageously errors can be avoided even before installation and/or implementation, which would lead to high time and costs for troubleshooting after installation.

In a further preferred embodiment of the disclosure, checking compatibility comprises checking physical and/or technical properties of the new process module to be integrated with the physical and/or technical properties of the at least one further process module of the modular network. Typically, in the context of the disclosure, the physical and/or technical properties comprise hardware properties of the hardware used. The hardware used can be used to check the compatibility of a further process module with a new process module to be integrated. For this purpose, hardware specifications stored in the process module description are recorded or retrieved and compared with each other via the functionality comparison function.

In another embodiment of the disclosure, checking compatibility comprises checking chemical properties. For example, process modules have process fluids according to their functions and/or corresponding process fluids are mixed together by the process modules. By including a new process module in a group of existing process modules or to check compatibility with further process modules, corresponding process fluids can be checked for compatibility, mixing reactions or undesired reactions. For example, it can be checked whether acids are used by a process module. Thus, a water component must first be provided and then the acid component can be installed to minimize/avoid undesirable reactions, damage and/or risk/injury to operators. The compatibility check thus determines whether the water component is provided and only then would an acid component be released. Possible damage to the machine and humans is thus prevented even before implementation and commissioning.

In a further preferred embodiment of the disclosure, checking the compatibility comprises checking the type and/or the number of physical interfaces of the process modules. For the communication of the process modules with each other and with the automation unit, it is necessary that the physical interfaces of the process modules are designed to be compatible with each other and are designed according to the same standard. This enables error-free communication. In addition, it is necessary that the process modules have the correct physical interfaces in the same number.

In another preferred embodiment of the disclosure, checking compatibility comprises checking the materials used in the component and/or process module. In terms of the present disclosure, material verification refers to a compatibility of the specification with respect to the material flow and/or physical properties of the component and/or the materials it processes. Thus, material testing need not always relate to the material of the components used themselves. For example, limits on viscosity, temperature and/or pressure may be tested.

In another preferred embodiment of the disclosure, the checking comprises checking the resilience of materials used, in particular with respect to power supply, flow rate, buffer capacity, temperature and/or pressures applied.

In another preferred embodiment of the disclosure, checking compatibility comprises checking pneumatic and/or hydraulic and/or electrical characteristics. For example, the flow rate and/or the flow velocity may be checked. Furthermore, it may be provided that the properties of the pneumatic and/or hydraulic conduits, for example the thickness of the piping, are checked.

In another preferred embodiment of the disclosure, the physical characteristics of the new process module to be integrated are acquired via a simulation. Typically, the physical characteristics of the new process module to be integrated are captured via a simulation based on a Functional Mock-up Interface (FMI). The Functional Mock-up Interface (FMI) is an independent industry standard. This standard defines standardized interfaces used in computer simulations for the development of cyber-physical systems. One advantage is that a standardized description of the interface to the simulation model is given. For example, a file provides a standardized description of the variables and functions of the interface to the model. The model can be provided as an open-source code, as a non-viewable and closed binary file, or by passing the simulation values with other tools. Thus, model exchange and co-simulation of models in different development tools can be easily provided. An FMI simplifies the use of tools for specific modeling tasks and the consistent reuse of models in different development phases. In FMI-based simulation, a container and interface are generated for the exchange of dynamic models using XML files, binaries, and C code stored in a single file. The container corresponds to the functional mock-up unit (FMU). Thus, via FMI-based simulation, a real automation unit with a number of process modules interacting in complex ways and controlled by a number of complex physical laws can be created as a virtual element or product, consisting of a number of different physical (software) models. An FMU corresponds to a physical model that interacts with the other physical models in a simulation environment via the FMI interface definition, and thus in context represents a real automation unit. The physical properties of a process module can advantageously be checked for compatibility with the FMI-based simulation of a further process module. The FMI-based simulation can thus be used to ensure and guarantee the physical compatibility and corresponding load limits.

According to one embodiment of the present disclosure, after the compatibility check, a detailed report is generated as a result, from which the detected incompatibilities can be extracted, if any. The generated report includes all deviations from the MTP standard and shows inconsistencies with the AML guidelines and, if applicable, other detected errors. Based on the report, appropriate actions can be taken automatically or by a user to correct the deviations and thus establish compatibility between the process modules. In addition, the report may contain information about limits for function parameterization. The limits may be based on actual physical constraints of one of the process modules, or may be derived from implicit requirements of specified safety margins and safety requirements of the process modules. The report is provided in electronic form, e.g., as a results file, e.g., for display on a UI (user interface). The report may include a statistical analysis of the review results (e.g., an accumulation of faults in a particular area of the plant and/or in a particular time period to allow further conclusions to be drawn). The report may also include warnings if incompatibilities are found continuously and/or too frequently. The report enables simplified and efficient diagnosis and evaluation of the verification results, and appropriate action to be taken to resolve the incompatibilities. Further, the report may include likely constraints on operation in the modular interconnect. These restrictions may be defined, for example, by limits to be complied with.

In an alternative embodiment, the report may be output visually and/or audio-visually on an output unit, such as a monitor, display, handheld, etc. The display enables simplified and efficient diagnosis and evaluation of the verification results, and appropriate action to be taken to resolve the incompatibilities.

In a further preferred embodiment of the disclosure, acquiring the first process module description of the new process module to be integrated and/or retrieving the second process module description of the at least one further process module comprises a syntactic validation according to pre-definable rules and, in particular, according to conformity with an MTP standard and with an AML syntax. The first process module description and/or the second process module description are syntactically validated. In another preferred embodiment of the disclosure, the syntactic validation comprises reading out the structural composition of a module type package file and checking the read-out structural composition for conformance with a reference. In one embodiment, the reference may be (or comprise) an MTP description file whose correctness has been verified or validated and which may be used as a corresponding template for matching. Thus, the process module description may be validated and verified for syntactic correctness. The process module description, in particular the description file, is thereby checked for conformity with the rules and regulations specified in the MTP standard. During this check, the general structure is checked. This includes checking whether the objects described in the description file are specified according to the MTP standard and are described (coded) in an AML-compliant manner. In addition, the AML-compliant combination of the individual objects in the entire description file, as required or intended according to the MTP standard, is validated. Thus, logical and/or content-related errors with respect to the objects mapped in the description file can be identified and corrected. The information technology coherence of the description file-internal objects can thus be validated.

In an advantageous way, syntactic checking can reveal errors in the process module description that could make technical accessibility and thus verification more difficult. In this respect, the semantic correctness describes the quality of the process module description. The optional additional check of the semantics of the process module description can ensure that subsequent processing steps can prepare the contents in the appropriate manner, as intended by the specification, without causing an erroneous state during integration.

In a further preferred embodiment of the disclosure, the syntactic validation may further comprise checking whether the elements encoded in the module type package file are in a predefined correct relation to each other. Advantageously, this checking verifies that the elements make sense and that they are positioned and linked to each other. For example, it can be checked whether all interactive symbols specified in the MTP description file and used in a user interface have a corresponding link to a corresponding element from a communication set (in order to be able to ensure that the symbol is interactive). Further advantageously, the MTP description file is checked for triviality. In this check, it is determined whether a non-empty MTP and AML compliant description is present in each of the communication, control panel and/or functionality sections. For this purpose, a library can be accessed in the MTP standard, the “SystemUnitClass-Library”, in which the components are specified. For example, sensors, tanks, valves, etc. can be specified, which are described in abstract form or of a general nature. For this purpose, separate classes are created for the different components, which are instantiated and internally linked and thus become part of a special MTP. Different aspects of the components can be addressed via the MTP, for example the operating screen, communication structures or services, which must also be internally linked and interconnected. This linking must be compliant with each other. This is checked according to the disclosure.

This allows the automation unit to be validated for error correctness. Through the corresponding validation, correctly linked or interconnected components of a process module (e.g. valves, switches, pumps, etc.) can be identified before implementation and an inoperability of the process module after implementation can be avoided.

In another preferred embodiment of the disclosure, the syntactic validation comprises an execution of at least one subroutine by a processor unit. The processor unit may in particular verify the use of elements in the module type package/MTP file. Advantageously, the syntactic validation may be executed by a series of subroutines. A subroutine may be created for each syntactic validation. The subroutines may be executed individually or together in an automated manner.

In another preferred embodiment of the disclosure, the syntactic validation comprises an execution of at least one subroutine by a processing unit, which in particular verifies the positioning of the used elements in the module type package file. By positioning the used elements in the module type package is meant their arrangement on a syntactic basis. For example, a corresponding subroutine can be used to verify correct indentation and bracketing. Indentation can be used to define the beginning or end of an element specified in the process module description. Incorrect indentation can lead to incorrect interpretation and thus to an error during integration. Syntactic validation prior to implementation can identify and correct an error.

In a further preferred embodiment of the disclosure, the syntactic validation comprises an execution of at least one subroutine by a processing unit, which in particular verifies the correct use of variables, parameters and/or attributes. With the subroutine it can be verified whether all elements defined in the module process description, variables, parameters and/or attributes defined according to the MTP standard have been assigned and whether they have been assigned corresponding values. In addition, the subroutine can check whether the correspondingly defined types are adhered to for the variables. A missing and/or incorrect use of the variables, parameters and/or attributes is verified by the subroutine. Thus, an erroneous integration of the process module can be prevented. In one embodiment, a corresponding library, for example the library “SystemUnitClassLibrary”, may be used for validating the attributes of the elements. The attributes of the elements are compared with the respective defined attributes from the library. An inconsistency is detected and noted or provided accordingly.

In a further embodiment of the disclosure, the syntactic validation comprises an execution of at least one subroutine by a processing unit, which in particular checks the library used whether it complies with the MTP standard.

In a further preferred embodiment of the disclosure, syntactic validation comprises an execution of at least one subroutine by a processing unit, which in particular verifies the correct use of elements from verified process libraries. Thus, it can be verified that the elements used are deployed and used according to their specification.

In another aspect, the disclosure relates to a (process) industrial computing unit. The industrial computing unit is adapted to perform the computer-implemented method according to the present disclosure. The industrial computing unit comprises an acquisition interface, a retrieval interface and a processor unit for checking a compatibility of a new process module to be integrated with at least one further process module for integration into a modular network of process modules for controlling an automation unit.

The industrial computing unit may take the form of a programmable logic controller, a PC or industrial PC, and/or a software implementation hosted on a computer. The industrial computing unit has various human-machine communication (HMI) interfaces, as well as interfaces for communicating with the process modules and/or the automation unit. The HMI interfaces include input and output devices to condition the industrial computing unit. The interfaces for communication with the process modules and/or the automation unit comprise wireless interfaces (WLAN, Wifi, Bluetooth, etc.) and/or wired interfaces (RS232, RS485, Ethernet, USB, etc.). The processing unit is connected to the interfaces of the industrial computing unit via a bus. Alternatively, the industrial computing unit may be implemented on a microcontroller or an FPGA or an ASIC in hardware.

In a further aspect, the disclosure relates to the use of the computer-implemented method according to any one of the method claims of the present disclosure for integrating a new process module to be integrated into a group of process modules of an automation unit in which compatibility with at least one further process module has been successfully verified.

The solution of the above-mentioned object was described above on the basis of the claimed method. Features, advantages or alternative embodiments mentioned therein are also to be applied to the other claimed subject matter and vice versa. In other words, the subject matter of the apparatus claims (which are directed, for example, to a process-industrial computing unit or to a computer program product) may also be further formed with the features described and/or claimed in connection with the method and vice versa. The corresponding functional features of the method are thereby formed by corresponding structural modules, in particular by hardware modules or microprocessor modules, of the process-industrial computing unit or the product, and vice versa.

Another solution for the object provides for a computer program, with program elements (computer code) for carrying out all method steps of the method described in more detail above, when the computer program and its program elements are loaded into a memory of the computer and thus executed on the computer. Thereby, it is also possible that the computer program is stored on a medium readable by a computer.

Further advantageous embodiments and further embodiments of the disclosure will be apparent from the subclaims and from the following detailed description with reference to the figures.

In the following detailed figure description, embodiments which are not to be understood restrictively are discussed with their features and further advantages with reference to the drawing.

### BRIEF DESCRIPTION OF THE DRAWINGS

The disclosure will now be described with reference to the drawings wherein:

FIG. 1 shows a graphical representation illustrating a possible embodiment of an industrial computing unit according to the disclosure;

FIG. 2 shows a flowchart illustrating a possible embodiment of a method according to the disclosure;

FIG. 3 shows a graphical representation explaining a possible embodiment of a module orchestration;

FIG. 4 shows a graphical representation of a possible operating diagram for controlling a process module of an automation unit according to one embodiment of the disclosure;

FIG. 5 shows a graphical representation of a possible AML, file according to one embodiment of the disclosure; and

FIG. 6 shows a graphical representation of a stored data class in the instance list according to one embodiment of the disclosure.

### DESCRIPTION OF EXEMPLARY EMBODIMENTS

The accompanying drawings are intended to provide a further understanding of embodiments of the disclosure. They illustrate embodiments and, in connection with the description, serve to explain principles and concepts of the disclosure. Other embodiments and many of the advantages mentioned will be apparent with reference to the drawings. The elements of the drawings are not necessarily shown to scale with respect to each other.

In the figures of the drawing, elements, features and components which are identical, have the same function and the same effect are to be provided with the same reference signs in each case—unless otherwise stated.

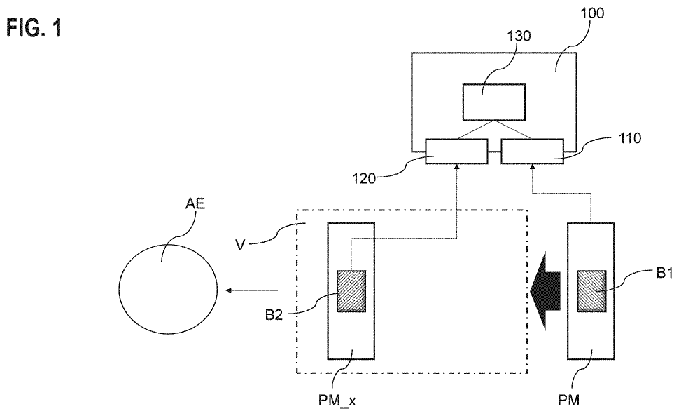

FIG. 1 shows a block diagram illustrating a possible embodiment of an industrial computing unit according to the disclosure. In FIG. 1, reference numeral 100 denotes the industrial computing unit. The industrial computing unit 100 is adapted to execute the computer-implemented method 10 according to the present disclosure. The industrial computing unit 100 comprises a processor unit 130. In particular, the computer-implemented method 10 according to the present disclosure is executed by the processor unit 130 of the industrial computing unit 100. The processing unit 130 is connected to an acquisition interface 110 and a retrieval interface 120 via a bus, typically a communication bus. The acquisition interface 110 is configured to acquire a first process module description B1 of the new process module PM to be integrated. In a preferred embodiment, the first process module description B1 is encoded according to an MTP standard. The retrieval interface 120 is configured to retrieve a second process module description B2 of the at least one further process module PM_x. According to another preferred embodiment, the second process module description B2 is encoded according to the MTP standard. However, coding the process module description B1 according to the MTP standard does not necessarily mean that the rules and regulations of the MTP standard have been taken into account when coding the process module description B1. Advantageously, with the method 10 according to the disclosure executed by the industrial computing unit 100, the compatibility is checked by executing a functionality comparison function on the acquired first process module description B1 and the retrieved second process module description B2.

If the result of the executed functionality comparison function shows that the acquired first process module description B1 of the new process module PM to be integrated is compatible with the retrieved second process module description B2 of the further process module PM_x, the new process module PM to be integrated can be integrated into the group V of process modules PM_x. Advantageously, it may be assumed that no error occurs during integration, due to established interoperability. In FIG. 1, the interconnection or network V is shown with only one further process module PM_x. However, this is only shown in this way for reasons of simplification and does not exclude the possibility that further process modules PM_x are integrated and/or can be provided in order to control an automation unit AE or to provide functions for it.

The embodiment shown in FIG. 1 represents the industrial computing unit as a computer or an industrial PC. In alternative embodiments, the industrial computing unit 100 may be formed in a programmable logic controller, in a microcontroller, in a computing unit of the automation unit AE, or in a microcontroller of a process module (hardware). Alternatively, the industrial computing unit 100 may be implemented in hardware on an FPGA or provided as a software implementation hosted on a computer (server). In this case, the industrial computing unit 100 has corresponding interfaces for communication.

The industrial computing unit 100 may further comprise at least one further interface (not shown) for human-machine communication. This may be designed for connection to an output unit. Via the output unit, a report on the result of the compatibility check may be provided/displayed. Further, this interface may be configured to connect to an input unit. Input from an operator may be received via the input unit. Further, a further interface may be provided to provide data communication with storage devices and/or further computing units.

The acquisition interface 110 and the retrieval interface 120 may be wireless interfaces (WLAN, Wifi, Bluetooth, etc.) and/or wired interfaces (RS232, RS485, Ethernet, USB, etc.).

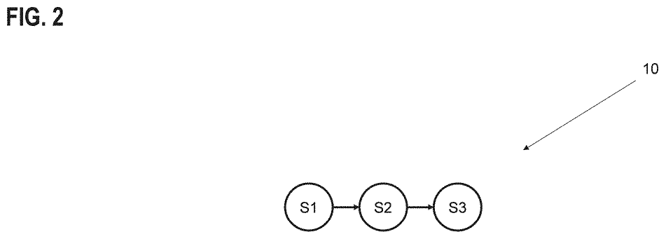

FIG. 2 shows a flowchart illustrating a possible embodiment of a method according to the disclosure. In the illustrated embodiment example, the computer-implemented method 10 comprises several steps. In a first step S1, a first process module description B1 of the new process module PM to be integrated is acquired. The first process module description B1 is in particular encoded according to an MTP standard. Acquiring the first process module description B1 may comprise reading the memory of the new process module to be integrated, or inputting the first process module description B1 by an operator, or providing the first process module description B1 via a storage medium. In a second step S2 of the method according to the disclosure, a second process module description B2 of the at least one further process module PM_x is retrieved. The second process module description B2 is in particular encoded according to the MTP standard. Retrieving the second process module description B2 may comprise reading the process module description B2 from a memory of the corresponding process module or automation system. Moreover, the retrieved process module description B2 may be provided by an operator via a storage medium or via another storage medium in communication with the process module, the automation system or the industrial computing unit. In a further step S3, compatibility checking is performed by executing a functionality comparison function on the acquired first and retrieved second process module description B1, B2.

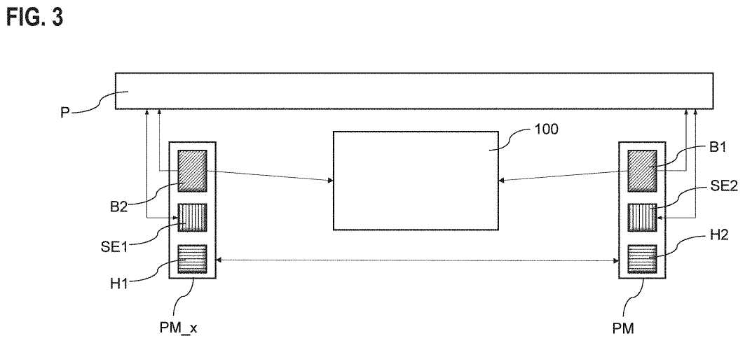

FIG. 3 shows a block diagram illustrating a possible embodiment of a process module orchestration. In FIG. 3, the reference sign P denotes the process control level as the higher-level system. This can be designed as the automation unit AE. The process control level P orchestrates the respective process modules PM, PM_x used or to be used. For this purpose, the process modules PM, PM_x provide their process engineering functions as a service and the process control level P calls up these services in each case in accordance with an overall process. The functions of the automation unit AE can be extended or renewed by the pre-automated modular process modules PM, PM_x. The modular process modules PM, PM_x can be easily added, arranged and/or adapted according to production needs through their process module description B1, B2. This can be achieved by the process module description B1, B2 which is coded according to the MTP standard. Thus, interoperability between each process module PM, PM_x and the automation unit AE is enabled. The process modules PM, PM_x shown in FIG. 3 comprise a local control SE1, SE2. The local controller can be designed as an OPC-UA server. The control of the process module PM, PM_x is provided via the OPC-UA server. The description file with the process module description B1 as well as the OPC-UA server of the process module PM to be newly integrated is implemented via an automation and software integration into the automation unit AE via the process control level P. Furthermore, the process modules PM, PM_x comprise corresponding module hardware H1, H2. The hardware module H2 of the new process module PM to be integrated is implemented via hardware integration in the automation unit AE via the process control level P.

The industrial computing unit 100 is adapted to execute the computer-implemented method according to the present disclosure. The industrial computing unit 100 checks the compatibility of the process module description B1 of the new process module PM to be integrated with the process module description B2 of the at least one further process module PM_x using a functionality comparison function. The result of the compatibility check may be rendered as a detailed report. The report identifies incompatibilities based on which modifications, additions and/or error correcting actions may be performed. In addition, a semantic check and a syntactic verification of the MTP description file comprising the process module description B1, B2 may be performed by the industrial computing unit 100. The semantic verification comprises comparing the provided functions of the new process module PM to be integrated with the requirements of the at least one further process module PM_x. It is checked for conformance of the provided functions with the requirements. The syntactic verification comprises the verification of the MTP description file B1 of the new process module PM to be integrated according to predefined rules and in particular according to conformity with the MTP standard and with an AML syntax. The verification may be provided via individual subroutines executed by the processing unit 130 of the industrial computing unit 100. As an output of the verification, a detailed report may be generated in an automated manner that outlines all deviations from the MTP standard, and identifies inconsistencies or missing aspects. Based on the detailed report, changes, additions and/or error correcting actions may be performed.

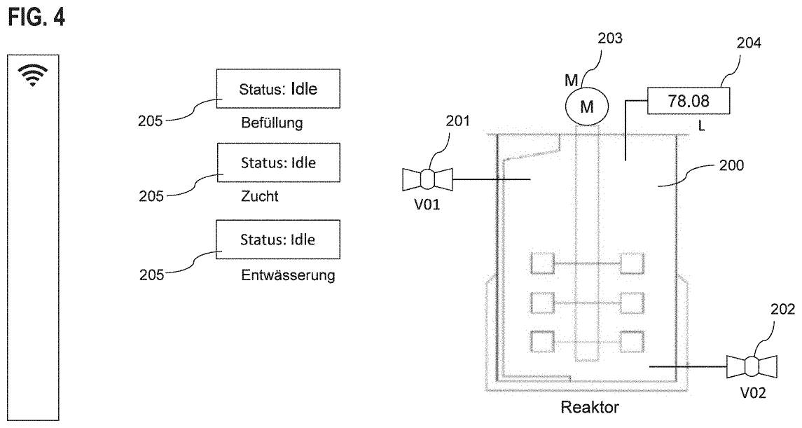

FIG. 4 shows a block diagram to illustrate a possible operating screen for the control of a process module of an automation unit. In this representation, the logical description of the MTP file of the process module PM, PM_x is shown or visualized. The representation is based on the MTP SUCLib entries and can be generated automatically therefrom. This MTP unit is provided with the process module PM, PM_x to be integrated and the control panel is generated on corresponding execution units (PC, processor) and displayed on connected output units (displays, HMI's). In FIG. 4, an exemplary bio-reactor with a reactor tank 200 is schematically shown. The reactor tank 200 is shown as a passive visual object (icon). In addition, active objects (symbols) are shown in FIG. 4. Active symbols are interactive objects which can be addressed (triggered) via signals and can be changed in their display state via these signals. Reference signs 201, 202 are used to denote the active symbols for the pumps in the inlet area and in the outlet area of the reactor tank 200. The pumps 201, 202 are represented differently depending on their operating state. For example, a “green” representation may indicate a “pump active” operating state, a “red” representation may indicate a “pump stop” operating state, and a “yellow” representation may indicate a “pump fault” operating state. This enumeration indicates only an exemplary embodiment and may comprise further operating states or comprise a different embodiment with respect to the colors and the state. In addition, FIG. 4 shows the symbol for a motor 203 and a level sensor 204. Furthermore, services 205 are shown in FIG. 4. For example, the services 205 may include a “Filling” service to fill the bioreactor, a “Cultivate” service to perform the bioreaction, and a “Draining” service to drain the final product. These services have a status. According to the MTP standard, services act according to a state machine. The control panel shown in FIG. 4 can be designed as an interactive control panel, whereby, for example, by selecting a service (mouse click, touch), the service can be started or stopped, or a valve can be opened or closed, or the motor can be started or stopped. The present disclosure advantageously checks and validates the services and the active/passive objects to be displayed in the control panel for compatibility with further process modules. If the result of the functionality comparison function is that the acquired first process module description and the retrieved second process module description are not compatible, the result may be output or displayed via an error report. This can trigger another function, so that corrective actions should be initiated before the actual implementation takes place.

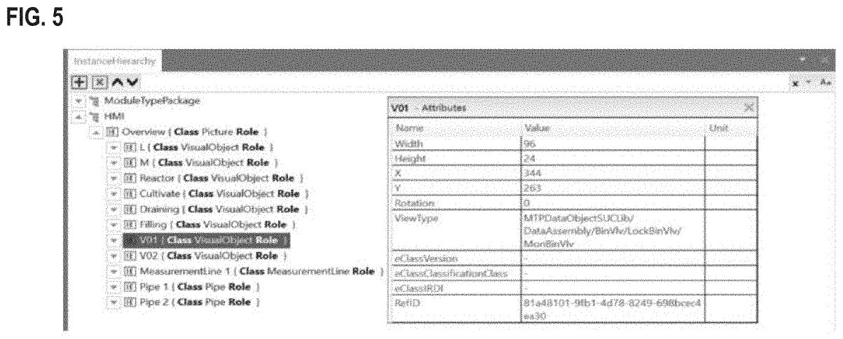

FIG. 5 shows a block diagram to illustrate a possible AML file on which the dynamic control panel (HMI) of FIG. 4 is based and can be generated. The file is displayed open in an AML editor as a visualization tool. In the AML editor the different symbols are listed. The symbols are listed in the instance hierarchy. The properties of a symbol to be displayed, such as size and position of the symbol and the data type used (viewtype) can be taken from the listing. In addition, a reference ID is used to link the symbol to the corresponding data class. The listing also includes components for which no runtime data is stored—such as pipes. Furthermore, contact points can be specified in the AML file (not shown in FIG. 5).

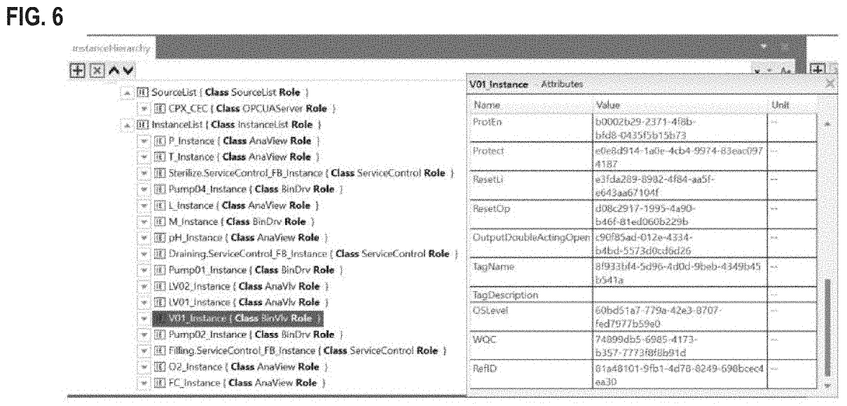

FIG. 6 shows a block diagram for displaying a stored data class in the instance list. A data class is stored for each dynamic MTP object. The various properties are created in the respective data class via the reference IDs. The actual structure results from the SUCLib. Based on the reference ID linking, a relationship can be established between the dynamic MTP object (often symbol) and—ultimately stored on the OPC UA server—associated values and control parameters.

Finally, it should be noted that the description of the disclosure and the embodiments are in principle not to be understood restrictively with respect to any particular physical realization of the disclosure. All features explained and shown in connection with individual embodiments of the disclosure may be provided in different combinations in the subject matter according to the disclosure in order to simultaneously realize their advantageous effects.

The scope of protection of the present disclosure is given by the claims below and is not limited by the features explained in the description or shown in the figures.

In particular, it is obvious to a person skilled in the art that the disclosure can be applied not only to pneumatic automation units, but also to hydraulic systems or other fluid power systems or electrical axes. Furthermore, the components of the computing unit can be realized distributed on several physical products. Likewise, the process steps can also be executed on different computer instances—and thus as a distributed system.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

AE Automation unit
B1 first process module description
B2 second process module description
H1/H2 Hardware module
P Process control level
PM Process module
PM_x further process module(s)
SE1/SE local control
V modular network, interconnection or composite or group
10 Computer-implemented method
S1-S3 Process steps
100 process computer
110 Acquisition interface
120 Call-off interface
130 Processor unit
200 Reactor tank
201 Pump
202 Pump
203 Engine
204 Sensor
205 Services

What is claimed is:

1. A computer-implemented method for checking a compatibility between a process module to be newly integrated and at least one further process module in a modular network of process modules for controlling an automation unit, the method comprising:
acquiring a first process module description of the new process module to be integrated;
retrieving a second process module description of the at least one further process module; and
verifying compatibility by performing a functionality comparison function on the acquired first and retrieved second process module descriptions.

2. The method according to claim 1, wherein the first and/or the second process module description comprises a description file in an Automation Markup Language format and represents control logic information for operation in the automation unit and is in particular encoded according to an MTP standard.

3. The method according to claim 1, wherein checking compatibility comprises semantically checking whether functions provided by the new process module to be integrated match requirements of the at least one further process module and vice versa.

4. The method according to claim 1, wherein the new process module to be integrated and/or the at least one further process module provide at least one of the following functions:
an alarm management,
a safety procedure and/or security procedure,
a process control and/or a process method,
a maintenance and diagnostic procedure, and/or
a communication procedure.

5. The method according to claim 1, wherein checking compatibility comprises checking physical properties of the new process module to be integrated with the physical properties of the at least one further process module of the modular network, and
wherein the physical properties comprise hardware properties.

6. The method of claim 5, wherein verifying compatibility comprises verifying:
a type and/or number of physical interfaces of the process modules,
materials used,
pneumatic, chemical and/or hydraulic properties, and/or
a load capacity of materials used, in particular with regard to energy supply, flow rate, buffer capacity, temperature and/or pressures applied.

7. The method according to claim 5, wherein the physical properties of the new process module to be integrated are acquired via a simulation, in particular via a Functional Mockup Interface based simulation.

8. The method according to claim 1, wherein acquiring the first process module description of the new process module to be integrated and/or retrieving the second process module description of the at least one further process module comprises a syntactic validation according to pre-definable rules and in particular according to conformity with an MTP standard and with an AML syntax.

9. The method of claim 8, wherein the syntactic validation comprises reading the structural makeup of a Module Type Package file and checking the read structural makeup for conformance to a reference.

10. The method of claim 9, wherein the syntactic validation further comprises verifying that the elements encoded in the Module Type Package file are in a predefined correct relation to each other.

11. The method of claim 8, wherein the syntactic validation comprises executing at least one subroutine by a processing unit that in particular verifies on:
use of elements in the module type package file,
positioning of the used elements in the Module Type Package file,
correct use of variables, parameters and/or attributes, and/or
correct use of elements from verified process libraries.

12. Use of the method according to claim 1 for the integration of a new process module to be integrated into a network of process modules of an automation unit, in which the compatibility with at least one further process module has been successfully checked.

13. A computer program comprising program elements for causing a computer to perform the steps of the method according to claim 1 when the program elements are loaded into a memory of the computer.

14. Process-industrial computing unit for carrying out the computer-implemented method according to claim 1, having an acquisition interface, a retrieval interface and a processor unit for checking compatibility between a process module to be newly integrated and at least one further process module in a modular network of process modules for controlling an automation unit.
